(19) United States
(12) Patent Application Publication
(10) Pub. No.: US 2017/0332617 A1
(43) Pub. Date: Nov. 23, 2017

(54) SELF-ADHESIVE FILM FOR SOIL FUMIGATION

(71) Applicant: ARKEMA FRANCE, COLOMBES (FR)

(72) Inventor: THIERRY FOUILLET, SAUVAGNON (FR)

(21) Appl. No.: 15/525,170

(22) PCT Filed: Nov. 5, 2015
(86) PCT No.: PCT/FR2015/052988

§ 371 Date: May 8, 2017

(30) Foreign Application Priority Data
Nov. 10, 2014 (FR) 1460834

(51) Int. Cl. A01M 13/00; B32B 7/12; B32B 27/32; B32B 27/30; A01M 17/00; B32B 27/36; B32B 27/08

(52) U.S. Cl. CPC A01M 13/003; B32B 27/36; B32B 7/12; B32B 27/08; B32B 27/306; A01M 17/002; B32B 27/32; B32B 2250/24; B32B 2307/7242; B32B 2405/00; B32B 2410/00

(57) ABSTRACT

The present invention relates to the use of a fumigant barrier film for treating soil by fumigation, said film having, on at least one portion of the outer surface thereof or on at least one portion of the inner surface thereof or on at least one portion of the outer and inner surfaces thereof, at least one continuous self-adhesive or self-sticking or tackifying area. The present invention also relates to the method for sealing soil intended for fumigation treatment or in the process of fumigation treatment or which has been treated by fumigation, by covering said soil with a self-adhesive fumigant barrier film, as well as to a kit for fumigation treatment including at least one self-adhesive fumigant barrier film and at least one fumigant.

The present invention relates to the field of soil fumigation, i.e. the treatment of soils or substrates for plants (composts, peat, rock wool etc.), especially substrates intended for agriculture, to control nematodes, pathogenic fungi, weeds, harmful insects or bacteria.

The fumigation technique is now widely used for disinfecting soils or substrates for plants, notably those intended for intensive agriculture and notably those intended for arboriculture, horticulture and market gardening.

This fumigation technique employs at least one fumigant, generally a volatile pesticide, which is introduced into the soil or substrate to be treated, by various techniques known by a person skilled in the art, for example using colters, or soil injection nozzles (shank application), or drip application. This fumigation technique also comprises the use of at least one fumigant in the form of gas or mist, above the soil or plant substrate to be treated.

The fumigant diffuses into the soil or more generally into the substrate to be disinfected, but also rises to the surface and may be dissipated into the atmosphere. Large quantities of fumigant may be lost in this way, leading to a loss of efficacy of the product used. Moreover, the fumigant thus dissipated in the atmosphere may be troublesome, or even toxic for farmers and others in the immediate vicinity of the crops and fields treated.

To overcome this drawback, soil treated by fumigation is commonly covered with a polymer film that is impermeable to the vapors of the fumigant, as described for example in EP0766913. This plastic cover, impermeable to gases, prevents said fumigant dispersing into the air above the soil or substrate being treated. There is therefore a space between the soil or substrate and the polymer film, in which the fumigant vapors are concentrated, thus reinforcing the efficacy of said fumigant. Various types of films, such as polyethylene films, of the SIF type (“semi-impermeable film”), VIF type (“virtually impermeable film”), or TIF type (“totally impermeable film”), are now used when treating soils or substrates by fumigation.

Films for disinfection of agricultural soils may be classified in two categories depending on the duration of use:

a) Category 1: “simple” protection: These films are kept in place during the required disinfection time of the substrate to be treated, and are then removed prior to planting. This category comprises two subcategories, depending on whether or not the films are assembled together by gluing:
i) films put in place without gluing, film on film
ii) films whose surface condition allows assembly of the widths by gluing in situ;
b) Category 2: protection and mulching: The films in this category firstly provide protection during disinfection, and then are kept in place as mulching films.

The present invention relates in particular to the first category, where the films are assembled together, but also to the second category, where the films may also be assembled together.

The polymer films are advantageously placed on the soil or substrate, before or after the fumigation treatment, and are left in place for the time required for effective control of nematodes, phytopathogenic fungi, weeds, harmful insects and other bacteria. After this treatment time, the duration of which largely depends on the soils or substrates to be treated, the climatic conditions, the type of crop envisaged, and other things, the polymer films may either be removed or simply perforated, to allow planting of the crops.

The use of polymer films in fields offers other advantages such as an increase in soil temperature particularly at the beginning of spring, reduction of problems connected with the appearance of weeds, conservation of humidity, reduction in the number of certain insect pests, higher yields and more efficient utilization of the soil nutrients.

Most mulching films are generally black for weeding, white for cooling, or clear for short-term disinfection or for warming the soil. The temperature of the soil under a plastic mulch depends on the thermal properties (reflection, absorption or transmission) of the particular material of which the film is constituted, relative to the incident solar radiation.

For example, black mulches conserve moisture and heat while preserving weed infestation. Black, the dominant color used in vegetable production, is an opaque absorber and a radiator. A black mulch absorbs most of the ultraviolet (UV), visible and infrared (IR) wavelengths of the incident solar radiation and reemits a proportion of the energy absorbed in the form of thermal or infrared radiation. A large part of the solar energy absorbed by black plastic mulch is lost to the atmosphere by radiation and by forced convection.

However, transparent polymer films absorb little solar radiation, but transmit from 85% to 95% of said radiation, with a relative transmission that is a function of the thickness and degree of opacity of the film. The surface under these polymer mulches is generally covered with droplets of condensed water. This water is transparent to the incident short-wave radiation, but is opaque to the infrared thermal radiation emitted: heat lost to the atmosphere from bare soil by infrared radiation but which is retained by the transparent polymer mulch.

As for white films, they may lead to a slight decrease in soil temperature relative to bare soil, as they reflect, in the plant cover, most of the incident solar radiation. These mulches may be used for establishing a crop when soil temperatures are high, for example in regions with very high insolation and where any reduction in soil temperature is beneficial.

A large number of polymer films are already widely used in agriculture, some of which combine photocatalytic properties, as described for example in application WO2013030513, and which are quite particularly suitable for soil fumigation.

However, one of the difficulties associated with the use of these so-called fumigation films is that they need to be positioned, or even repositioned, on the soil so as to provide a seal that is as perfect as possible so that all or at least the greater part of the fumigating gases is retained, as far as possible avoiding any escape of fumigant into the atmosphere, as the health authorities of a large number of countries now stipulate application of an impermeable film on any soil being fumigated.

Thus, to completely cover a previously fumigated soil, parallel widths of films are commonly distributed on said soil and then a seal is made between said widths of films, by gluing the widths together, edge to edge. Gluing the widths together is now a widely known technique and is used notably for fumigation treatment with methyl bromide, and has now been extended to fumigation treatments with other fumigants.

Thus, it is now known to place plastic films so that they overlap one another slightly, by joining or gluing by several different techniques (cf. for example U.S. Pat. No. 4,050,972), employing various types of adhesives, among which we may mention:

adhesives diluted in a solvent, for example rosin-based adhesives in dichloromethane; however, these types of adhesives employing solvents present the additional difficulty of subsequently removing said solvent,
so-called “hot melt” adhesives, as described for example in U.S. Pat. No. 8,535,461, but these require hot application, and therefore expensive additional operations involving considerable extra labor.

All these known techniques for completely sealing soil covered with widths of fumigation films therefore require one or more additional operations which most often are tricky or difficult to carry out, and generate extra costs that are often prohibitive for the farmer, who must comply with the standards and regulatory authorities regarding crop fumigation.

Therefore there is still a need for fumigation films that are easy to use and notably whose installation on fields and soils for crops in general is facilitated in particular so that sealing between the widths of films is easily carried out.

The invention now proposed makes it possible to overcome, completely or at least partly, the known drawbacks of the prior art and notably the difficulties encountered in ensuring sealing of the fumigation films. Other objectives are also achieved by the present invention, a detailed account of which is given in the following description.

Thus, according to a first aim, the present invention relates to the use, for fumigation treatment of soils, of a fumigant barrier film that has, on at least one portion of its outer surface or on at least one portion of its inner surface or on at least one portion of its outer and inner surfaces, at least one continuous self-adhesive or self-sticking or “tackifying” area.

The present invention thus proposes the use, for fumigation treatment of soil, of at least one barrier film, i.e. that is impervious to the vapors of the fumigant, and possesses tackifying power on the inner and/or outer face of the film, so as to create at least one continuous self-adhesive area, generally continuous and parallel to the largest length of the film, so that the widths of film placed parallel to one another on the soils ensure imperviousness to the fumigant. According to one embodiment of the invention, the whole of the outer or inner surface of the film constitutes the self-adhesive area of the film.

The use according to the present invention makes it possible to omit the additional step or steps of sealing by gluing and/or welding together the widths of fumigation film. The so-called “self-adhesive” films used in the present invention can be put in place by the conventional techniques for placing so-called conventional fumigation films and imperviousness to the fumigant is provided owing to the properties of the “self-sticking” or “self-adhesive” film. It is also possible, in order to ensure perfect hermeticity and perfect gluing of the widths together, to apply pressure on the continuous self-adhesive area, and said pressure may notably be applied during placement of the fumigation film, by any means known by a person skilled in the art, and for example, but not limited to this, using a pressing roller or pressing roll.

According to a preferred embodiment, the invention relates to the use of a self-adhesive film that may be applied by at least one of the following techniques:

a) placing a width of self-adhesive fumigant barrier film, overlapping another width of said self-adhesive fumigant barrier film, optionally applying pressure on the overlapping area, simultaneously or after placement of the width or widths of self-adhesive fumigant barrier film,
b) simultaneously placing a width of conventional (i.e. not self-adhesive) fumigant barrier film and a small strip of self-adhesive fumigant barrier film, between two widths of conventional, i.e. not self-adhesive, gas barrier film, optionally applying pressure on the small strip of self-adhesive film, simultaneously or after placement of the width or widths of fumigant barrier film,
c) alternately placing a width of self-adhesive fumigant barrier film overlapping a conventional (i.e. not self-adhesive) fumigant barrier film, optionally applying pressure on the overlapping area, simultaneously or after placement of the widths of fumigant barrier film.

The invention also relates to the method for sealing soil intended for fumigation treatment or in the course of fumigation treatment or that has been treated by fumigation, said method consisting of covering the whole or at least one portion of said soil with a fumigant barrier film having at least one continuous self-adhesive area. Preferably, the method for sealing soil according to the invention comprises one of the three techniques described above under a), b) or c).

“Fumigant barrier film” means a film that is impermeable to the fumigant, where impermeability is defined according to standard NF T54-195-2:2014.

It was discovered, quite surprisingly, that it is possible to combine, in one and the same fumigation film, properties of impermeability to the fumigant and self-adhesiveness. In fact, it has to be understood that the self-adhesive area, of varying size, or even completely self-adhesive notably for reasons of simplicity of using the film, must also have the “fumigant barrier” character required for any fumigation film.

Thus, the use according to the present invention is characterized by the use of a fumigant barrier film containing at least one continuous self-adhesive area, continuous and parallel to the largest length of the film, on at least one portion of its outer surface or of its inner surface or on its outer and inner surfaces.

Self-sticking or self-adhesive films are already known and are available commercially, some of which are now in use for the manufacture of stretch films, notably polyethylene stretch films, notably for food packaging, for protecting loads on pallets, for ensilage, and others applications, as described for example in application WO2013061264.

Most often the self-adhesive properties of these films are obtained by adding an effective amount of one or more adhesive agents or “tackifying” agents to the polymers of these films. All the tackifying agents currently known may be used and, among these, we may advantageously mention rosin derivatives, polyterpenes, hydrocarbon-containing tackifying resins of low molecular weight, for example poly(iso-butene), also known by its acronym PIB.

Among the known methods of manufacture, we may mention those that employ a masterbatch based on polyolefin comprising a tackifier, for example based on polyethylene (PE) containing PIB, with the masterbatch representing between 1 and 20 wt %, preferably from 1 to 15 wt %, relative to the total weight of the tackifying film.

PIB is for example now commonly used for making self-adhesive films such as those listed above for making stretch films, for food packaging, for protecting loads on pallets, for ensilage, etc.

The tackifying agents that may be used for preparing films suitable for the needs of the present invention are known and are readily available, generally in liquid form, but also and advantageously in masterbatch form, i.e. diluted in a polymer matrix, for example in a polyethylene matrix. The tackifying agent is thus advantageously added in masterbatch form to the polymer during manufacture of the plastic film.

The films usable in the context of the present invention may consist of one or more layers. At least one layer is a layer containing a suitable amount of tackifying agent, in other words one or more of the layers may each contain a suitable amount of tackifying agent. “Suitable amount” means an amount that provides effective adhesion of the film on itself or on any other plastic film that is a barrier to the gas of the fumigant, while allowing unsticking.

According to one embodiment of the invention, the fumigation film comprises at least one layer comprising a polymer selected from polyolefins, polyamides and polyesters, and preferably bio-sourced and/or biodegradable polyolefins, polyamides and polyesters. “Polyolefin” means, in the sense of the present invention, a polymer or random or block copolymer, resulting from the polymerization, or copolymerization, respectively, of monomers that are olefins, preferably selected from ethylene, propylene, 1-butene, and others, and mixtures thereof.

As examples of polyolefins, we may mention:

propylene-based polymers, such as homopolymer propylenes, copolymers of propylene with ethylene and/or an olefin comprising from 4 to 10 carbon atoms (e.g. butene, pentene, hexene, and others), heterophasic polypropylenes or mixtures thereof, these polymers being obtainable by any method known by a person skilled in the art, for example in suspension or in the gas phase with catalysts of the Ziegler-Natta or metallocene type;
polyethylenes selected from ethylene homopolymers or copolymers comprising at least 50 mol % of ethylene and one or more other comonomers.

According to a preferred embodiment, a polyolefin that may be used is polyethylene obtained by polymerization, preferably homopolymerization of ethylene, but also by copolymerization with an a-olefin, and notably an a-olefin having from 2 to 30 carbon atoms. As a-olefin, we may mention propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene, and 1-triacontene.

As other co-monomers of copolymers with polyolefins described above, we may also mention:

dienes, for example 1,4-hexadiene, ethylidene-norbornene, butadiene,
esters of unsaturated carboxylic acids, for example the alkyl acrylates or the alkyl methacrylates grouped together with the term “alkyl (meth)acrylates”, and the alkyl chains of these (meth)acrylates may comprise up to 30 carbon atoms, with as examples of alkyl chains: methyl, ethyl, propyl, n-butyl, sec-butyl, isobutyl, tent-butyl, pentyl, hexyl, heptyl, octyl, 2-ethylhexyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, the methyl, ethyl and butyl (meth)acrylates being preferred,
unsaturated carboxylic acids and salts thereof, for example acrylic acid or methacrylic acid and the salts of these same acids,
vinyl esters of carboxylic acids, among which we may mention vinyl acetate, vinyl versatate, vinyl propionate, vinyl butyrate, vinyl maleate, vinyl acetate being quite particularly preferred.

Among the polyesters usable for the fumigation films, we may mention bio-sourced or biodegradable polyesters, and more preferably those selected from:

polylactides: for example polymers and copolymers of lactic acid (PLA) or polymers and copolymers of glycolic acid (PGA);
poly(hydroxyalkanoates), homo- or copolymers (or PHA): for example poly(hydroxybutyrates) (PHB), hydroxybutyrate-valerate copolymers (PHBV), for example poly(3-hydroxybutyrate)-poly(3-hydroxyvalerate), hydroxybutyrate-hexanoate copolymers (PHBHx), and hydroxybutyrate-hexanoate copolymers (PHBO);
poly(alkylene) succinates (PAS), for example poly(ethylene) succinate or PES, and poly(butylene) succinate or PBS;
other polymers such as poly(butylene) succinate-adipate or PBSA, poly(butylene) adipate-terephthalate or PBAT, poly(caprolactone) or PCL, poly(trimethylene-terephthalate) or PTT.

The term “biosourced” or “renewable” applies to a natural resource whose stock can be replenished in a short time on the human scale, the resource having to be renewed as quickly as it is consumed. In the context of the present invention, bio-sourced materials correspond to organic materials whose carbon atoms are derived from non-fossil resources (cf. ASTM 6866: “Biobased Materials—organic materials in which the carbon comes from contemporary (non-fossil) biological sources”).

The term “biodegradable” applies to a material that can be degraded by microorganisms. The result of this degradation is mainly the formation of water, carbon dioxide and/or methane, and possibly byproducts (residues, new biomass) that are not toxic to the environment.

For the needs of the present invention, the polyolefins used advantageously are those selected from polypropylene, polyethylene, copolymers of ethylene and an α-olefin, ethylene/alkyl (meth)acrylate copolymers, copolymers of ethylene/vinyl esters of carboxylic acids.

The polymer layer, of which a polyolefin and more particularly polyethylene is preferably the main constituent, and advantageously the only constituent, comprises at least one tackifying agent or tackifying resin, as stated above.

As a variant, the fumigation films usable in the context of the present invention may comprise one or more other polymer layers, or may consist of one or more other polymers containing at least one tackifying agent or tackifying resin, and said polymers may then be selected from the nitrogen-containing and/or oxygen-containing polar resins, for example from polyamides, copolyamides, ethylene/vinyl acetate copolymers (EVOH), polyesters and copolyesters, for example polyglycolic acid (PGA), thermoplastic starches and mixtures of two or more of them in all proportions.

“Polyamide” means, in the sense of the present invention, a polymer or copolymer comprising the condensation products:

of one or more amino acids, such as the aminocaproic, amino-7-heptanoic, amino-11-undecanoic and/or amino-12-dodecanoic acids;
of one or more lactams, such as caprolactam, oenantholactam and/or lauryllactam;
of one or more diamines, optionally in the form of salts, such as hexamethylenediamine, dodecamethylenediamine, metaxylylenediamine, bis-para-aminocyclohexylmethane and/or trimethylhexamethylenediamine with one or more diacids, for example selected from the isophthalic, terephthalic, adipic, azelaic, suberic, sebacic and dodecanedicarboxylic acids;
or mixtures of these monomers leading to copolyamides.

It is possible to use mixtures of polyamides and/or copolyamides.

According to a preferred embodiment, the fumigation film usable in the present invention comprises a polymer selected from nylon-6, nylon-66, and ethylene/vinyl acetate copolymers, in particular the saponified copolymers of vinyl acetate and ethylene (EVOH), and mixtures thereof.

The films usable according to the present invention must moreover possess suitable mechanical strength for manipulation on the ground, mechanical strength that is manifested in much easier handling. Notably, the films are not pierced and do not tear, even when the film placed on the soil is trodden on by the feet of the users, warehouse workers, farmers and others, but also during placement of the widths of film on the soil to be protected by the machines and equipment intended for this purpose.

According to yet another variant, the films usable in the context of the present invention may comprise or consist of one or more other polymers, and notably so-called compatibilizing polymers, which are generally used to make the polymers compatible with one another or two layers of polymers compatible with one another, so that they can be assembled in the form of two-layer or multilayer film.

It is in fact known that certain polymers of different natures are not very compatible with one another, and it is often difficult to join them together. This is in particular the case with two-layer or multilayer films comprising a layer based on polyolefin(s) and a layer based on polyamide(s) (PA) or EVOH, for example PA/EVOH films or PA/EVOH/PA films.

Compatibilization, between polymers together and/or layers of polymers together, is described for example in applications FR 2 291 225, EP 0 342 066 and WO2013030513, and the polymers that may be used for this purpose are advantageously selected from:

propylene-based polymers, such as homopolymer propylenes, copolymers of propylene with ethylene or a monomer comprising from 4 to 10 carbon atoms (for example butene, pentene, hexene, and others), heterophasic polypropylenes or mixtures thereof, and these polymers may be synthesized by any method known by a person skilled in the art (for example in suspension, or in the gas phase with catalysts of the Ziegler-Natta or metallocene type);
polyethylenes selected from ethylene homopolymers or copolymers comprising at least 50 mol % of ethylene and one or more other comonomers, when the comonomer of the copolymer is an a-olefin, the a-olefins having from 2 to 30 carbon atoms being preferred, it being understood that as second monomer, we may mention those selected from:

dienes, for example 1,4-hexadiene, ethylidene norbornene, butadiene,

esters of unsaturated carboxylic acids, for example alkyl acrylates or alkyl methacrylates, grouped together with the term alkyl (meth)acrylates, and the alkyl chains of these (meth)acrylates may have up to 30 carbon atoms, and among these alkyl chains we may mention the methyl, ethyl, propyl, n-butyl, sec-butyl, isobutyl, tent-butyl, pentyl, hexyl, heptyl, octyl, 2-ethylhexyl, nonyl, decyl, undecyl, dodecyl, tridecyl, tetradecyl, pentadecyl, hexadecyl, heptadecyl, octadecyl, nonadecyl, eicosyl, hencosyl, docosyl, tricosyl, tetracosyl, pentacosyl, hexacosyl, heptacosyl, octacosyl, nonacosyl chains, the preferred unsaturated esters of carboxylic acid being the methyl, ethyl and butyl (meth)acrylates; and

vinyl esters of carboxylic acids, among which we may mention vinyl acetate, vinyl versatate, vinyl propionate, vinyl butyrate, or vinyl maleate, preferably vinyl acetate,

polyethylene, polypropylene, ethylene/α-olefin copolymers, for example ethylene/propylene, ethylene/butene copolymers, all these products being grafted by anhydrides of unsaturated carboxylic acids such as for example maleic anhydride or glycidyl methacrylate,
ethylene/alkyl (meth)acrylate/maleic anhydride copolymers, the maleic anhydride being grafted or copolymerized,
ethylene/vinyl acetate/maleic anhydride copolymers, the maleic anhydride being grafted or copolymerized,
ethylene/alkyl (meth)acrylate/glycidyl methacrylate copolymers, the glycidyl methacrylate being grafted or copolymerized,
ethylene/vinyl acetate/glycidyl methacrylate copolymers, the glycidyl methacrylate being grafted or copolymerized,
ethylene/(meth)acrylic acid copolymers and optionally salts thereof,
polyethylene, propylene or ethylene/propylene copolymers, these polymers being grafted by a product having a reactive site with the amines, for example maleic anhydride, epoxy, and others, these graft copolymers then being condensed with polyamides or polyamide oligomers having a single amine end, for example with mono-amino oligomers of caprolactam, as described for example in patents U.S. Pat. No. 5,070,145 and EP 0 564 338,
mixtures of one or more of these polymers and/or copolymers.

As stated above, one or more layers, in the case of multilayer films, of the fumigant film usable in the context of the present invention may contain at least one tackifying agent or tackifying resin, incorporated by the techniques known by a person skilled in the art.

In fact, as stated above, the fumigation films usable in the context of the present invention are known and commercially available or are easily prepared by techniques that are familiar to a person skilled in the art, and for example by the usual techniques of extrusion, of co-extrusion of sheaths, of extrusion and co-extrusion of cast-films, extrusion blow molding and others, using one or more extruders, or else with mixtures of polymers by the usual techniques of mixing in the molten state (twin-screw, Buss, single-screw), and other methods familiar to a person skilled in the art.

The various polymer and/or copolymer constituents of the multilayer films according to the invention may also contain one or more additives known by a person skilled in the art, selected from antioxidants, UV protectants, application aids, agents for preventing extrusion defects, anti-fume agents, antiblocking agents, antistatic agents, nucleating agents and colorants. These agents may be added to one or more of the layers making up the films of the present invention, by techniques and in proportions by weight that are also familiar to a person skilled in the art.

In particular, the films usable in the context of the present invention may comprise one or more agents, organic and/or mineral, for protection against ultraviolet radiation. In fact, the films of the invention are intended to be exposed to solar radiation for long periods and are thus liable to be degraded under the action of ultraviolet (UV) radiation. If they are not protected, this degradation is reflected in a plastic film that becomes opaque and friable.

According to a preferred embodiment, the films useful in the present invention may also comprise at least one agent that protects against degradation due to UV radiation. Protective agents of this kind are familiar to a person skilled in the art and may be selected from molecules of the benzophenone or benzotriazole type, the molecules known by the name “HALS” (acronym of “Hindered Amine Light Stabilizers”), as well as mineral anti-UV agents, for example TiO₂ in its non-photocatalytic form.

According to yet another variant of the invention, the fumigation films useful in the context of the present invention may also comprise one or more so-called “reinforcing” polymers, which may or not be inserted between the polymer layers making up said film. These reinforcing layers provide further reinforcement of the structure of the fumigation film.

The nature of these reinforcing layers may be of any type known by a person skilled in the art, and these layers may in particular comprise one or more of the polymers defined for the polymer layers defined above. It has to be understood that the adhesion of the reinforcing layer or layers may be improved by incorporating at least one compatibilizer in said layer or layers, or they may be co-extruded with a compatibilizing polymer, as described above.

According to yet another variant, the invention relates to the use of the fumigation films that have just been described and further comprising one or more colored layers. In fact, the films or plastic covers commonly used on soils or substrates for crops may need to be colored, depending on whether we wish to derive benefit from the temperature of the air or of the soil, preserve a certain degree of humidity, etc.

The films of the present invention may thus consist of or comprise an additional colored layer, white, black, or any other color defined according to the needs and the climatic and soil conditions. These colored layers may be obtained by techniques familiar to a person skilled in the art and, as a nonlimiting example, starting from masterbatches based on polyethylene (PE) containing one or more pigments intended to supply the color, for example carbon black for black color, titanium dioxide pigment for white color, etc.

The colored layer may comprise, just like all the other optional layers making up the film, at least one tackifying agent or at least one tackifying resin, as stated above. Moreover, in the case when the colored layer and the adjacent layer are not mutually compatible, it is possible to improve the adhesion between these two layers by using a compatibilizing agent or a compatibility layer, as described above.

The thickness of the fumigation film usable in the context of the present invention, which comprises one or more polymer layers, may vary widely. However, the various assembled polymer layers must endow the film with acceptable mechanical strength, and their respective thicknesses must not be too great, to avoid making said film rigid, as it must remain easy to manipulate. Thus, as a nonlimiting example, the thickness of each of the polymer layers is generally between about 5 μm and about 100 μm, preferably between 5 μm and 75 μm, preferably between 5 μm and 60 μm, more preferably between 5 μm and 50 μm. As a general rule, the total thickness of the self-adhesive film used in the context of the present invention is between 5 μm and about 100 μm, preferably between 5 μm and 75 μm, preferably between 5 μm and 60 μm, more preferably between 5 μm and 50 μm.

The fumigation films that have just been described may be placed on the soil either before beginning injection of fumigant(s), or immediately after said injection. The tackifying properties of the fumigation films described above allow particularly easy and effective provision of imperviousness to the vapors of the fumigant, for example by overlapping and gluing the strips (or widths) of films, but also by burying the edges of films in the earth, and/or any other techniques known by a person skilled in the art.

Thus, the method of sealing according to the present invention also comprises a step of injecting at least one fumigant immediately before placing the film, or after placing the film. When the fumigant is injected before placing the film, injection is preferably carried out in the soil, by any techniques familiar to a person skilled in the art and for example using colters. When the fumigant is injected after placing the film, the fumigant is injected by any methods known by a person skilled in the art and for example by drip injection on the soil itself.

The fumigation films usable in the present invention may be photocatalytic films, as described for example in patent application JP 9-263502 or else application WO2013030513. Owing to the presence of a photocatalyst, the fumigation films have, besides good mechanical strength and gas barrier effect properties, the capacity to photocatalyze the fumigant that is trapped between the soil and said film. Owing to ultraviolet radiation, for example from the sun, lamps used in greenhouses etc., this photocatalysis allows decomposition of the organic compounds, often toxic and/or malodorous, that are used for fumigation of said soils.

Owing to the fumigation films having tackifying properties and thus ensuring excellent imperviousness to soils covered by said films, it is possible to use any type of fumigants known by a person skilled in the art, selected from nematocides, herbicides, fungicides, insecticides, and bactericides, for example those listed in “Pesticide Manual”, 10th edition, Ed. Clive Tomlin.

In the present invention, “fumigant” means any type of plant protection compound simultaneously fulfilling at least the following two essential conditions: (i) at the doses at which it is active, not exert any phytotoxicity on the plants grown after the treatment and (ii) possess the rare essential property of not being completely absorbed in the soils or substrates for crops and of diffusing rapidly, in gaseous form, in the thickness of the soil to be treated, as the phytopathogenic organisms are often up to at least 50 centimeters beneath the surface of said soil or said substrate. Moreover, for obvious reasons of productivity, as well as to limit the risk of reinfestation, the treatment time during which the fumigant is active must be as short as possible.

As nonlimiting examples of fumigants, we may mention methyl bromide, methyl iodide, methyl isothiocyanate (MITC), allyl isothiocyanate (AITC), 1,3-dichloropropene, chloropicrin, ethanedinitrile (EDN), sulfuryl fluoride (SO₂F₂), phosphine, tetrathiocarbonate or other MITC-generating compounds, for example metam-sodium and metam-potassium, as well as tetrahydro-3,5-dimethyl-1,3,5-thiadiazine-2-thione (better known by the name Dazomet), as well as certain sulfur compounds, such as alkyl sulfides, dialkyl disulfides, dialkyl polysulfides, thiosulfinates and others, as well as mixtures of two or more of them in all proportions.

All these fumigating compounds are known and described extensively in the literature. International application WO2002074083 describes in particular fumigants based on sulfur compounds, and in particular the compounds corresponding to general formula (I)

R—S(O)ₙ—SₓR′ (I)

in which R is selected from the alkyl and alkenyl radicals containing from 1 to 4 carbon atoms, n is equal to 0, 1 or 2, x takes values in the range from 0 to 4, inclusive, and R′ is selected from the alkyl and alkenyl radicals containing from 1 to 4 carbon atoms or, only when n=x=0, R′ may represent a hydrogen or alkali metal atom.

The fumigants mentioned above, alone or mixed, and in particular those of formula (I) above, are quite particularly suitable for fumigation of soils or substrates, used together with the fumigation films usable in the context of the present invention and described above, as they fulfill three essential conditions for practical application in disinfection of soils or substrates: they have overall pesticide properties (nematocides, fungicides, herbicides, insecticides, bactericides); they are capable of diffusing rapidly through the thickness of the soil to be treated; and they lead to a sufficient concentration of gas to kill the phytopathogenic organisms present.

Among the fumigants currently known, those corresponding to formula (I) above are preferred for the needs of the present invention. In fact, as substitutes for methyl bromide, the compounds of formula (I) are all the more interesting as some of them are already present in nature, resulting from the natural degradation of crucifers and alliums. In particular, thiosulfinates, included in general formula (I), are products that are emitted naturally when alliums are crushed, and consequently may be used in biological agriculture.

Moreover, the compounds of formula (I) do not contain halogen atoms that generate halogenated radicals responsible for catalytic destruction of stratospheric ozone; the compounds of formula (I) are safe for the ozone layer. As nonlimiting examples of radicals R and R′, we may mention the methyl, propyl, allyl and 1-propenyl radicals.

Among the compounds of formula (I), those are preferred for which n=0, i.e. the compounds corresponding to formula (I′): (I′)

R—S—Sₓ—R′ (I′)

in which R and R′, which may be identical or different, preferably identical, each represent, independently of one another, an alkyl or alkenyl radical, preferably alkyl, containing from 1 to 4 carbon atoms, and x represents 1, 2, 3 or 4.

Other preferred compounds are the disulfides (n=0, x=1) and more particularly dimethyl disulfide (DMDS).

The fumigants described above, and in particular the compounds of formula (I) described above, may be used in the pure state or in various forms, for example in emulsions, in microemulsions, aqueous, organic or aqueous-organic, in the form of emulsifiable concentrate, as micro-encapsulated or nano-encapsulated products or products supported on a solid, in aqueous, organic, or aqueous-organic solutions, or else mixed with one or more products having activity for treating soils or substrates.

All the formulations defined above can be produced by methods familiar to a person skilled in the art. Thus, for example, the aqueous emulsions and the microemulsions may be obtained by adding one or more surfactants to the fumigating compound, and then adding a certain amount of water to the mixture obtained, to give a stable emulsion or a microemulsion.

Surfactants with a predominantly hydrophilic character, i.e. those having a hydrophilic/lipophilic balance (HLB) greater than or equal to 8, which may be of an anionic, cationic, nonionic or amphoteric nature, are more particularly suitable for preparing the aqueous emulsions or microemulsions.

As nonlimiting examples of anionic surfactants, we may mention the alkali-metal, alkaline-earth, ammonium or triethanolamine salts of alkyl-, aryl- or alkaryl-sulfonic acids, of fatty acids with basic pH, of sulfosuccinic acid or alkyl, dialkyl, alkaryl or polyoxyethylene-alkaryl esters of sulfosuccinic acid. We may also mention the alkali-metal or alkaline-earth salts of the esters of sulfuric, phosphoric, phosphoric or sulfoacetic acid and of saturated or unsaturated fatty alcohols, as well as alkoxylated derivatives thereof. Yet other surfactants are represented by the alkali-metal or alkaline-earth salts of alkarylsulfuric, alkarylphosphoric, and alkarylsulfoacetic acids, as well as alkoxylated derivatives thereof.

The cationic surfactants that may be used are, for example, those of the class of the quaternary alkylammoniums, sulfoniums or fatty amines with acid pH, as well as alkoxylated derivatives thereof. As nonlimiting examples of nonionic surfactants, we may mention alkoxylated alkyl phenols, alkoxylated alcohols, alkoxylated fatty acids, glycerol fatty esters or the fatty derivatives of sugar.

The amphoteric surfactants that may be used are, for example, alkyl betaines or alkyl taurines. The preferred surfactants for preparing the aqueous emulsions and microemulsions are the compounds based on alkylbenzene sulfonate and alkoxylated alkyl-phenol.

For the formulations of fumigant(s) in the form of solution, the organic solvents usable are hydrocarbons, alcohols, ethers, ketones, esters, halogenated solvents, mineral oils, natural oils and derivatives thereof as well as polar aprotic solvents such as dimethylformamide, dimethylsulfoxide or N-methylpyrrolidone. Biodegradable solvents, more particularly the methyl esters of colza oils, are particularly suitable.

According to a variant of the present invention, two or more fumigants may be used, jointly, mixed, alternately or sequentially. In particular, it is possible to use two or more fumigants having complementary or synergistic activities selected from 1,3-dichloropropene, EDN, sulfuryl fluoride (SO₂F₂), phosphine, methyl iodide, chloropicrin (CI₃C—NO₂), metam-sodium (CH₃—NHCS₂Na), metam-potassium (CH₃—NHCS₂K), sodium tetrathiocarbonate (Na₂CS₄), MITC (CH₃—NCS), AITC, Dazomet (an MITC-generator), and the compounds of formula (I), and in particular the dialkyl disulfides, for example DMDS.

In the context of the present invention, i.e. in combination with the fumigation films with tackifying properties described above, the fumigants and the compositions containing them may be applied according to any one of the conventional methods for introducing pesticides into the soil, for example colter injection, which makes it possible to introduce the product to a great depth, spraying on the soil, drip application by a conventional irrigation system or spraying of the “sprinkler” type. Introduction of the fumigating product or products into the soil or substrate for planting can be followed by distribution, for example by rotary spading machine in the case of injection in the soil.

The doses of fumigant(s) generally applied for obtaining the desired effect are generally between 150 g/ha and 1000 kg/ha, preferably between 1 kg/ha and 750 kg/ha and depend on the nature of the fumigant or fumigants used, the degree of infestation of the soil, the types of pests and of phytopathogenic organisms, the type of crop and soil or substrate, and the methods of application.

At the doses stated above, the required general pesticidal effect (simultaneously nematocide, fungicide, herbicide, insecticide and bactericide) is observed, and no or only negligible phytotoxic effect. Combining treatment with a compound of formula (I) with treatment (whether or not simultaneous) with one or more other pesticides, insecticides and/or fungicides and/or with a fertilizer, falls within the scope of the present invention.

The present invention also relates to the use of the fumigation films with tackifying properties as have just been described, in methods of fumigation of soils or substrates intended for crops, in particular for market-gardening and horticultural crops, such as, as nonlimiting examples, strawberries, salad plants, tomatoes, melons, cucumbers, aubergines, carrots, potatoes, banana, pineapple, ornamental flowers, but also arboriculture and grapevine, and others.

The films usable in the context of the present invention may also be used on soils, substrates or more simply articles that are not necessarily intended for crops, but are liable to fungal infestations, and/or infestations of insects, nematodes, and other insects, larvae, nits, vermin. Possible uses are for example in the field of storage of wood, hay, straw, cereals, and more generally any food or non-food commodity liable to be degraded by fungi, insects, larvae, nematodes etc.

The invention also relates to a kit for fumigation treatment comprising at least one self-adhesive (tackifying) fumigant barrier film as described above, and at least one fumigant, preferably at least one volatile sulfur-containing organic compound, preferably of formula (I) or of formula (I′), and more preferably said fumigant comprises dimethyl disulfide.

The present invention further relates to the method of fumigation of a soil, of a cultivatable substrate or of an article, comprising at least the following steps:

a) application in said soil, substrate or article, and/or on the surface of said soil, substrate or article, of at least one fumigant, as has just been defined, and
b) completely covering said soil, substrate or article with a tackifying film, as defined above, before or after step a).

In a preferred embodiment, the method of fumigation according to the invention comprises at least the following steps:

a) application in said soil, substrate or article, and/or on the surface of said soil, substrate or article, of at least one fumigant, as has just been defined;
b) completely covering said soil, substrate or article with a tackifying film, as defined above, before or after step a);
c) fumigation treatment by leaving said fumigant to act by itself under said film, for a time that may vary from a few days to several weeks; and
d) optional complete or partial removal, or simple perforation, of said film.

In the method described above, the term “tackifying film” denotes the fumigation film described above in the present description. As stated above, said tackifying film may comprise at least one tackifying agent and/or at least one tackifying resin. At least one portion of the film may comprise said at least one tackifying agent and/or said at least one tackifying resin. As a variant, the whole film is a tackifying film, i.e. said at least one tackifying agent and/or said at least one tackifying resin is distributed uniformly in said tackifying film.

As stated above, the tackifying film, completely or at least partly, may be distributed on the whole or at least one portion of the soil, substrate or article, as stated above, once the whole of said soil, substrate or article is covered hermetically with a fumigation film, imperviousness being provided completely or at least partially with a tackifying film as defined above.

In the method described above, the possibility of injecting at least one fumigant between the film and the substrate is thus envisaged. Injection of the fumigant or fumigants into the soil may be performed by any technique known by a person skilled in the art, and for example such as those described above.

After the fumigation step, the tackifying fumigation film used in the method of the invention may be removed, when it is considered that the fumigant or fumigants have fulfilled their role. Removal may be total or partial, or it may remain in place. In the latter case, the film may be perforated in one or more predefined places, where the crops will be planted, such as transplants for example.

The advantage connected with the use of a tackifying film as has just been defined is that it can be placed on the soil, substrate or article, before or after the so-called fumigation step, for example simply by unwinding the film onto said soil, substrate or article, imperviousness being provided by contact, optionally accompanied by varying pressure, of the widths (or strips) of films together, advantageously on their respective areas of overlap (or overlapping), to prevent any escape of the fumigant into the atmosphere, as the fumigant must be retained, for the time required for fumigation, between the soil, substrate or article and the fumigation film.

When the fumigation film used is a film with a photocatalytic effect, as stated above, the photocatalytic action is provided by exposure to ultraviolet radiation, for example direct sunlight, or by means of ultraviolet lamps, used for example for plants grown in greenhouses.

The effect of ultraviolet radiation is photocatalytic action of the particles of photocatalyst(s) present in all or part of the fumigation film; said photocatalyst degrades the vapors of the fumigant or fumigants, which are released from the soil or substrate being treated. After photocatalytic destruction of the vapors of the fumigant or fumigants, the plastic films may be removed completely or partly from the soils or substrates to allow planting of crops in the soils thus treated by fumigation.

According to yet another aspect, the invention relates to a kit for fumigation treatment of a soil comprising at least one tackifying film for fumigation as defined above, and at least one fumigant, preferably at least one volatile sulfur-containing organic compound, preferably of formula (I) or of formula (I′) as defined above, and more preferably said fumigant is dimethyl disulfide or DMDS.

The following examples illustrate the invention but without limiting its scope, which is defined by the appended claims.

### Manufacture of the PE or Barrier, Stretch and Adhesive Film

Among the known plastic films and in particular those used in the fields of food packaging, protection of elements stored on pallets or for ensilage for example, the films are often so-called “stretch films” that have tackifying properties. More particularly, an extremely stretchable and self-adhesive (tackifying, sticky) film may then be used up to 180% of its initial length. So that the film is optimized for stretch and adhesion, it may for example consist of two or more polymer layers, at least one of which may contain an elastomer, and at least one, identical or different, may contain a tackifier, such as PIB.

Other examples of fumigation films having tackifying properties are presented below:

Film No. 1a: conventional gas barrier film prepared by extrusion blow molding, and containing three layers as follows:

Polyethylene
EVOH
Polyethylene

Film No. 1b: conventional gas barrier film prepared by extrusion blow molding, with one tackifying layer:

Polyethylene
EVOH
Polyethylene + PIB

Film No. 1c: conventional gas barrier film prepared by extrusion blow molding, containing four layers, including one tackifying layer:

Polyethylene
EVOH
Polyethylene
Polyethylene + PIB

Film No. 2a: transparent photocatalytic gas barrier film prepared by extrusion blow molding, containing three layers as follows:

Polyethylene
EVOH
Polyethylene + photocatalytic TiO₂

Film No. 2b: gas barrier film, photocatalytic and transparent, with tackifying layer, prepared by extrusion blow molding, and containing four layers as follows:

Polyethylene
EVOH
Polyethylene + photocatalytic TiO₂
Polyethylene + PIB

Film No. 3a: colored photocatalytic gas barrier film, prepared by extrusion blow molding, and containing four layers as follows:

Polyethylene
EVOH
Polyethylene + photocatalytic TiO₂
Polyethylene + carbon black

Film No. 3b: colored photocatalytic gas barrier film, with tackifying layer, prepared by extrusion blow molding, and containing four layers as follows:

Polyethylene
EVOH
Polyethylene + photocatalytic TiO₂
Polyethylene + carbon black + PIB

Film No. 3c: colored photocatalytic gas barrier film, with tackifying layer, prepared by extrusion blow molding, and containing five layers as follows:

Polyethylene
EVOH
Polyethylene + photocatalytic TiO₂
Polyethylene + carbon black
Polyethylene + PIB

### Example of Application of a “Self-Adhesive” Gas Barrier Film

For this test, tackifying (or self-adhesive) films, corresponding to film No. 1b above, with three layers with a total thickness of 30 μm, width of 2.5 m and length of 100 m, are used. Two series of films are obtained by the extrusion blow molding technique, familiar to a person skilled in the art, using:

for the first series: a tackifying polyethylene masterbatch (PE)/PIB type PW 60, marketed by the company Polytechs, at a rate of 5%, 10% and 15% (i.e. 3 films) by weight of tackifying masterbatch relative to the total weight of the film, and
for the second series: a tackifying polyethylene masterbatch (PE)/PIB type PW 70, marketed by the company Polytechs, at a rate of 5%, 10% and 15% (i.e. 3 films) by weight of tackifying masterbatch relative to the total weight of the film.

Many techniques may be envisaged for stretching a film and covering soil that is intended to be fumigated with a film that is impervious to the fumigant vapors. Among these techniques, we may mention, for purposes of illustration, the following three techniques:

### Technique No. 1

Placement of the film is performed conventionally with a “filming” machine, for example a machine commonly used for fumigation treatment with methyl bromide, using a solvent adhesive or translucent hot-melt adhesive. The operation comprises placement of a first strip (or width) of self-adhesive fumigant barrier film, then gluing of a second width of film on a portion of this first strip of film, with an overlap width from about 10 cm to 30 cm.

### Technique No. 2

Using an existing filming machine, of the type described for example in application WO 2001/0119167, a first strip of gas barrier film (conventional, non-tackifying) and a second strip are placed, leaving a space about 5 cm to 20 cm wide between these two widths. Then, while placing the third strip, bonding the strip of self-adhesive gas barrier film (about 10 cm to 50 cm wide, typically 40 cm) between the 2 strips placed previously, by simple pressure.

### Technique No. 3

Using the filming machine from Technique 1 and/or from Technique 2, alternating placement of widths of non-adhesive (non-tackifying) barrier film and of self-adhesive (tackifying) barrier film, the widths generally being roughly 3 meters wide.

### Example of Application of a Film According to Technique No. 1

Application of the various films was carried out according to technique No. 1, namely with the filming machine used for fumigation treatment with methyl bromide.

A first strip of self-adhesive barrier film (film 1b)) is placed, and then a second strip of self-adhesive barrier film (film 1b)) is bonded to the edge of this first strip of film, by simple pressure, and so on, so as to cover the whole width of the field. The overlap area is about 20 cm.

All the tackifying fumigant barrier films that have been described in the present invention have satisfactory tackifying power for use in soil fumigation, while ensuring perfect imperviousness and thus retaining the fumigant vapors under the film, more precisely between the soil and the film, so that no fumigant vapor, or only very small amounts of fumigant, escape into the atmosphere.

The use, according to the present invention, of a self-adhesive fumigation film thus offers numerous advantages, among which we may mention:

possibility of sticking/unsticking, of the “Post-it™” type, therefore easy to remove and reposition. This also facilitates removal of the plastic cover,
possibility of using the same recycling channels as for conventional fumigation film,
ease of use of the film without any handling of adhesive during fumigation: the adhesive (or tackifying) agent is added to the film during manufacture, therefore there is no need to add an adhesive (hot-melt adhesive or solvent adhesive) on the strips of films already positioned on the field,
keeping an identical number of operators as observed during placement of conventional fumigation films,
final cost (material and time) lower compared to the gluing techniques for the strips of conventional films.

What is claimed is:

1. A method for fumigation treatment of soils, comprising using a self-adhesive barrier film having fumigant barrier properties and having an outer surface and an inner surface, wherein at least a portion of at least one of the outer surface or the inner surface comprises at least one of a continuous self-adhesive area, a continuous self-sticking area or a continuous tackifying area.

2. The method according to claim 1, wherein the at least one of the continuous self-adhesive area of the film, continuous self-sticking area or the continuous tackifying area of the film comprises i a continuous area parallel to the largest length of the film.

3. The method according to claim 1, wherein the film comprises at least one layer, said layer comprising a polymer selected from the group consisting of polyolefins, polyamides and polyesters; and wherein the film further comprises at least one of a tackifying agent or a tackifying resin.

4. The method according to claim 1 wherein the thickness of the self-adhesive fumigant barrier film is between 5 μm and about 100 μm.

5. The method according to claim 1 wherein the soils treated by fumigation comprise at least one of soils or substrates intended for market-gardening, horticultural crops, arboriculture, or grapevines.

6. A method for sealing a soil for fumigation treatment, said method comprising covering at least a portion of said soil with a self-adhesive barrier film wherein the film has fumigant barrier properties, an outer surface and an inner surface wherein at least a portion of the at least of one of the outer surface and the inner surface comprises at least one continuous self-adhesive area.

7. The method according to claim 6, wherein covering the soil by the self-adhesive fumigant barrier film comprises at least one of the following techniques:
a) placing a first width of the self-adhesive fumigant barrier film on the soil, overlapping an area of the first width of the self-adhesive fumigant barrier film with a second width of said self-adhesive fumigant barrier film, and optionally applying pressure on the overlapping area, simultaneously or after placement of the second width of self-adhesive fumigant barrier film;
b) placing a first width of not self-adhesive fumigant barrier film on the soil and placing a second width of not self-adhesive fumigant barrier film a distance from and parallel to the first layer of not self-adhesive fumigant barrier film and then placing a small strip of the self-adhesive fumigant barrier film between the first and second widths of the not self-adhesive, fumigant barrier film, whereby the small strip of self adhesive film overlaps the first and second widths of the not self-adhesive fumigant barrier film, and optionally applying pressure on the small strip of self-adhesive fumigant barrier film, simultaneously or after placement of the small strip of self-adhesive fumigant barrier film;
c) placing alternating widths of the self-adhesive fumigant barrier film and not self-adhesive fumigant barrier film on the soil, whereby the self-adhesive film overlaps an area of the not self-adhesive fumigant barrier film, and optionally applying pressure on the overlapping area, simultaneously or after placement of the widths of fumigant barrier film.

8. The method according to claim 6 further comprising a step of injecting at least one fumigant either immediately before covering the soil with the fumigant barrier film, or immediately after covering the soil with the fumigant barrier film.

9. The method according to claim 6, wherein the fumigant is selected from the group consisting of methyl bromide, methyl iodide, methyl isothiocyanate, allyl isothiocyanate, 1,3-dichloropropene, chloropicrin, ethanedinitrile, sulfuryl fluoride, phosphine, tetrathiocarbonate, metam-sodium, metam-potassium, tetrahydro-3,5-dimethyl-1,3,5-thiadiazine-2-thione, alkyl sulfides, dialkyl disulfides, dialkyl polysulfides, thiosulfinates and combinations thereof.

10. A kit for fumigation treatment of a soil wherein the kit comprises at least one self-adhesive fumigant barrier film and at least one fumigant.

11. The method according to claim 7 further comprising a step of injecting at least one fumigant either immediately before covering the soil with the fumigant barrier film, or immediately after covering the soil with the fumigant barrier film.

12. The method according to claim 7, wherein the fumigant is selected from the group consisting of methyl bromide, methyl iodide, methyl isothiocyanate, allyl isothiocyanate, 1,3-dichloropropene, chloropicrin, ethanedinitrile, sulfuryl fluoride, phosphine, tetrathiocarbonate, metam-sodium, metam-potassium, tetrahydro-3,5-dimethyl-1,3,5-thiadiazine-2-thione, alkyl sulfides, dialkyl disulfides, dialkyl polysulfides, thiosulfinates and combinations thereof.

13. The method according to claim 8, wherein the at least one fumigant is selected from the group consisting of methyl bromide, methyl iodide, methyl isothiocyanate, allyl isothiocyanate, 1,3-dichloropropene, chloropicrin, ethanedinitrile, sulfuryl fluoride, phosphine, tetrathiocarbonate, metam-sodium, metam-potassium, tetrahydro-3,5-dimethyl-1,3,5-thiadiazine-2-thione, alkyl sulfides, dialkyl disulfides, dialkyl polysulfides, thiosulfinates and combinations thereof.

14. The method according to claim 6, wherein the film comprises at least one layer, said layer comprising a polymer selected from the group consisting of polyolefins, polyamides and polyesters; and wherein the film further comprises at least one of a tackifying agent or a tackifying resin.

15. The method according to claim 6, wherein the thickness of the self-adhesive barrier film is between 5 μm and 100 μm.

16. The method according to claim 6, wherein the soils treated by fumigation comprise at least one of soils or substrates intended for market-gardening, horticultural crops, arboriculture, or grapevines.

17. The kit for fumigation treatment of a soil according to claim 10, wherein the at least one fumigant comprises at least one volatile sulfur-containing organic compound.

18. The kit for fumigation treatment of a soil according to claim 10, wherein the at least one fumigant comprises dimethyl disulfide.
